(19) United States
(12) Patent Application Publication
(10) Pub. No.: US 2024/0183489 A1
(43) Pub. Date: Jun. 6, 2024

(54) System, kit and electronic module for counterbalancing a weight force of an object

(71) Applicant: Hilti Aktiengesellschaft, Schaan (LI)

(72) Inventors: Simon KÄSMANN, München (DE); Guenther VEIK, Maeder (AT); Roland SCHAER, Grabs (CH); Michael LANZINGER, Neufraunhofen (DE); Antonios DRAGANIS, Tussenhausen (DE); Christian METZLER, Satteins (AT); Michael WIERER, Röthis (AT); Dragan STEVIC, Feldkirch-Testers (AT)

(21) Appl. No.: 18/286,043

(22) PCT Filed: Apr. 4, 2022
(86) PCT No.: PCT/EP2022/058864

§ 371 Date: Oct. 6, 2023

(30) Foreign Application Priority Data
Apr. 22, 2021 (EP) 21169808.9

(51) Int. Cl. F16M 13/04; B25J 19/00

(52) U.S. Cl. CPC F16M 13/04; B25J 19/0008

(57) ABSTRACT

A system for counterbalancing a weight force of an object is provided. The object is fastenable to a traction cable, wherein the traction cable is guided in or on a cantilever in the direction of a back structure of the system, wherein a second end of the cantilever can be accommodated by a back structure, and the system can be carried by a user of the system via the back structure. The system is characterized by an electronic module which includes an apparatus for winding up the traction cable and a motor for driving the apparatus for winding up the traction cable, wherein the system is configured to determine a counterforce for the weight force of the object and to transmit same to the object. It is particularly preferred for the purposes of the invention that a control device of the system is configured to adjust a counterforce with respect to the weight force of the object. The system can preferably be configured to create a force balance between the weight force of the object on the one hand and the counterforce on the other hand. An electronic module for counterbalancing a weight force of an object, and to a kit which includes such an electronic module, a traction cable, and at least one deflection pulley. With the invention, the weight force of an object, which can be fastened to a traction cable of a counterbalancing system, can be compensated for particularly well and in a way that is easy on the back.

The present invention relates to a system for counterbalancing a weight force of an object. The object is fastenable to a traction cable, wherein the traction cable is guided in or on a cantilever in the direction of a back structure of the system, wherein a second end of the cantilever can be accommodated by a back structure, and the system can be carried by a user of the system by means of the back structure.

### BACKGROUND

The use of power tools, such as chiseling devices, hammer drills, core drilling devices or the like, is often strenuous and tiring, especially when working with these devices for a relatively long period of time. Power tools are often heavy and the downward weight force of such a tool toward the ground means that work with such tools can only be performed for a limited period of time before a break is required. However, this can delay the progress of work on a construction site, which is undesirable for various reasons.

### SUMMARY OF THE INVENTION

Furthermore, working with heavy power tools for many years may lead to physical limitations. There is therefore a need to provide means that make working with heavy power tools easier and effectively protect the users of such power tools from adverse health effects.

Users of power tools often have different physical requirements for working with a power tool. This may include, for example, height or the physical strength available for the work. In this respect, it would be desirable if the means to be made available are designed as flexibly as possible and can be individually adapted to different physical requirements.

Passive assistance systems, for example, are known in the prior art. In these passive assistance systems, an object can be fastened to a component of the assistance system, the object then being held by the assistance system. Especially when working with power tools that are to be fastened to an assistance system and with which work is sometimes carried out very dynamically, such a passive suspension cannot provide sufficient support for the user in some applications.

An object of the present invention is to overcome the above-described deficiencies and disadvantages of the prior art and to provide a system for counterbalancing a weight force of an object that is easy to handle and can be flexibly adapted to different users. In addition, the system to be provided is intended to effectively and reliably counterbalance the weight force of an object in different applications and situations. It would be desirable if this could be made possible without a special adjustment operation by the user of the system. Experts would also appreciate it if the system to be provided could enable not only static but also dynamic support for the system user. A further object on which the invention is based is to provide an electronic module as the drive and control unit of such a system, and to provide a kit with which the electronic module can be used, for example, as a stand-alone apparatus.

The present invention provides a system for counterbalancing a weight force of an object, wherein the object is fastenable to a traction cable, wherein the traction cable can be guided in or on a cantilever in the direction of a back structure of the system, wherein the cantilever can be accommodated by the back structure. The counterbalancing system is characterized in that the system comprises an electronic module which comprises an apparatus for winding up the traction cable and a motor for driving the apparatus for winding up the traction cable, wherein the system is configured to determine a counterforce for the weight force of the object and to transmit same to the object. It is particularly preferred for the purposes of the invention that the system comprises a control device, wherein the system is configured, for example, by the control device to adjust a counterforce with respect to the weight force of the object. The control device can preferably be configured to create a force balance between the weight force of the object on the one hand and the counterforce on the other hand. In addition, the system or the electronic module can have an energy source for supplying the system with electrical energy. The system preferably represents a battery-operated, body-borne counterbalancing or balancing system in which the weight force of an object is compensated for by generating a counterforce, with the counterforce being transmitted by a traction cable. A significant advantage of the system is that it can also be carried on a user's back. Consequently, the system represents a portable system that differs in terms of its portability from stationary manipulators, as are known from the prior art.

The system can preferably be configured to carry out a counterbalancing operation with respect to the weight force of the object. This counterbalancing operation can be carried out, for example, by the control device of the system. The counterbalancing operation preferably represents a control and regulating process with respect to the position of an object fastened to the traction cable of the system. The term counterbalancing operation relates in particular to the counterbalancing of a weight force of an object in a system, wherein the object can be fastened to a traction cable of the system. This can be a one-off operation which is carried out, for example, when work with the object is started or when a new object is fastened to the traction cable of the system. The counterbalancing operation can also be performed substantially continuously to allow substantially continuous weight counterbalancing of the object while working with it.

The object can in particular be a power tool with which work is to be performed. For example, it can be a chiseling device, a hammer drill, a fastening device or a similarly large and/or heavy device that is used, for example, to work on a wall or to drive an object to be fastened into a wall or a substrate. A person skilled in the art is familiar with such power tools.

The object or power tool can be fastened to a traction cable of the system using suitable fastening or receiving apparatuses. It is preferred for the purposes of the invention that the traction cable connects the object to an apparatus for winding up the traction cable, wherein the apparatus for winding up the traction cable is preferably provided in the region of the back structure of the system. The winding apparatus is preferably configured to extend or shorten an effective length of the traction cable. This is done, for example, as part of the counterbalancing operation, in which the weight or the weight force of the object is determined and used to set and control the effective length of the traction cable. However, it is particularly preferred for the purposes of the invention that a possible change in the weight force of the object is reacted to substantially continuously by the motor generating more or less torque and applying same to the traction cable. The apparatus for winding the traction cable can, for example, release the traction cable or shorten its length in order to adjust the effective length of the traction cable. For the purposes of the invention, it is very particularly preferred that the torque of the motor is adapted to different weight forces, preferably continuously, i.e. essentially throughout the use of the system, in order to counterbalance any changes in weight force. Advantageously, as a result, movements of the object that can occur when working with the object can be substantially continuously compensated for and the user can thus be permanently supported. As a result, the user of the system is considerably relieved of load when working with the object because, when using the system, the user has to apply only the force required for carrying out the work, and no longer has to apply the force for holding the power tool. In other words, the counterbalancing of the weight force of the object is transferred from the user to the system, and therefore in particular the system user's arm and shoulder muscles are freed from this. The force which has to be applied for carrying out the work can, for example, be a pressing force in order to propel the power tool or a tool thereof into a wall or into a substrate to be worked on. It is preferred for the purposes of the invention that the winding apparatus has at least one pulley which is preferably arranged in the region of an output of a drive device of the system. The traction cable is guided in or on a cantilever of the system in the direction of a back structure. It is preferred for the purposes of the invention that the traction cable runs from the object in the direction of a first end of the cantilever, wherein the first end of the cantilever may preferably also be referred to as the front end of the cantilever. It is preferred for the purposes of the invention that the traction cable is guided over deflection pulleys inside the cantilever. Within the context of the invention, however, other types of guidance may also be preferred, which include, for example, Bowden cables and/or plain bearings.

In a preferred embodiment of the invention, the cantilever is substantially L-shaped. The cantilever preferably comprises a back section and a head section, the back section and the head section being arranged substantially perpendicular to one another. It is preferred for the purposes of the invention that the back section of the cantilever runs substantially parallel to a spine of the system user, while the head section of the cantilever runs above or next to the user's head, substantially perpendicular to the back section and/or the spine of the user. It is preferred for the purposes of the invention that the cantilever or the head section thereof can be guided over the user's head or next to the user's head. As a result, a particularly flexible and versatile system can be provided. The guidance of the cantilever above or next to the system user's head is shown in FIGS. 4 and 5. The transition region between the back section and head section of the cantilever can be L-shaped, can comprise a transition section or can be designed as a joint. A transition region designed as a transition section between the back section and head section of the cantilever leads to a particularly stable structure of the system, while a joint that can be provided in the transition region between the back section and head section of the cantilever enables the system to be able to be folded, which means that the packing size of the folded-up system can be significantly reduced.

It can also be preferred for the purposes of the invention that the back section and/or the head section of the cantilever comprise joints which also allow the system to be folded and the system to be easily transported in the folded-up state. The joints can divide the back section into a lower and an upper region or the head section into a front and a rear region. It is preferred for the purposes of of the invention that the cantilever has a first end and a second end. The first end of the cantilever, which may also be referred to as the front end for the purposes of the invention, preferably forms the front end of the head section. The second end of the cantilever, which may also be referred to as the lower end for the purposes of the invention, preferably forms the lower end of the back section.

The terms “top”, “bottom”, “front” and “rear” do not represent unclear terms for a person skilled within the context of the present invention, since the terms and the spatial directions “upward”, “downward”, “forward” and “backward” associated therewith are explained, for example, in FIG. 1. For example, the weight force of the object usually acts in a spatial direction “downward”, i.e. in the direction of the ground on which the user of the system is standing. The spatial direction “upward” corresponds to the direction in which the object is moved when the effective length of the traction cable is shortened by the traction cable winding apparatus. During normal use of the system, the object is located in front of the user, for example at head, chest or stomach height. The head section of the cantilever usually represents the highest point of the system, such that in the terminology of the invention it forms the upper end of the system. The back section of the cantilever forms the rear region of the system. The back structure with the electronic module, the motor for driving the winding apparatus and the control device is provided in the rear, lower region of the system. The lower end of the system can be formed, for example, by a hip belt with which the system can be fastened on the user. For the purposes of the invention, this hip belt forms a first contact region at which there is physical contact between the system user and the system. A second contact region can be formed by back padding.

Preferably, the cantilever of the system can be accommodated by the back structure. It is particularly preferred for the purposes of the invention that the second end of the cantilever can be accommodated by the back structure. For the purposes of the invention, this preferably means that there is a connection between the lower end of the back section of the cantilever and the back structure. For example, the lower end of the back section of the cantilever, or the second end of the cantilever, can be accommodated by a cavity in the back structure of the system. In addition, fastening means can be provided with which the cantilever or the back section thereof can be fastened to or in the back structure. For example, the cantilever can be screwed to the back structure. Of course, other joining techniques for fastening the cantilever to the back structure are also conceivable. For example, the system can comprise a preferably one-piece construction that forms a transition between the cantilever and the back structure. In particular, the cantilever can merge into the back structure in the region of this construction.

For the purposes of the invention, it is preferred that the cantilever extends from the back structure above or next to the user's head in order to pick up and hold an object in front of the user's body. As a result, the system user is considerably relieved of load and can carry out the work to be performed with the object for significantly longer and with a reduced risk of adverse health effects. For the purposes of the invention, it is particularly preferred that the system can be carried by a user of the system by means of the back structure.

The system comprises an electronic module, wherein the electronic module can be arranged in particular in the region of the back structure of the system. The electronic module can be part of the system or can be designed as a stand-alone apparatus. The stand-alone design of the electronic module represents a further aspect of the invention, which is explained further below.

The electronic module comprises an energy source for supplying electrical energy to the system. The energy source can be a battery or a rechargeable battery (“power pack”), wherein the power pack is in particular rechargeable. If the object, the weight of which is counterbalanced by the system, is a battery- or power pack-operated power tool, it is preferred for the purposes of the invention that the energy source is similar to or the same as the energy source of the power tool. In other words, it is preferred for the purposes of the invention if substantially the same batteries and power packs can be used for the power supply of the system and of the power tool.

The electronic module also comprises an apparatus for winding up the traction cable and a motor for driving said apparatus. It is preferred for the purposes of the invention that the apparatus for winding up the traction cable is arranged in a region of the back structure and the traction cable can be wound up using the motor. The motor of the system is configured to generate a torque that can be used to extend or shorten the effective length of the traction cable. This is done preferably depending on a movement when guiding the object. Preferably, the torque of the motor can be used to hold, wind and/or release the traction cable depending on how the user changes the position of the object. The counterbalancing operation takes place in particular when a new object is fastened to the traction cable of the system. This can be the case, for example, when a power tool is exchanged because a different job is to be done. As part of the counterbalancing operation, regulation to the static weight or the weight force of the object is undertaken, with the controlled variable being in particular the torque of the motor. For the purposes of the invention, however, it may also be preferred for the counterbalancing operation to represent a substantially continuously running control and regulating process in which the motor rotational speed in particular is regulated to the “zero” rotational speed, i.e. to a standstill, or to a very low motor rotational speed. The velocity of the attached object can be, for example, less than 10 mm/s, more preferably less than 5 mm/s and most preferably around approx. 3.7 mm/s. This corresponds to a value for the motor rotational speed of less than 1 rad/s.

The counterbalancing operation is designed in particular as an automatic counterbalancing operation, in which the system responds preferably automatically to the weight force of the object or to changes thereof by the torque on the motor of the system being correspondingly regulated. An alternative counterbalancing operation can consist, for example, in that the object is pulled up from a substrate by the system after a preferably manual control input by the user, if the object was previously placed on the substrate. Within the context of this second counterbalancing operation, the torque of the motor in particular can be regulated or used as a controlled variable.

It is preferred for the purposes of the invention that the traction cable is wound up in a single layer within the winding apparatus. This preferably single-layered rolling up can be brought about, for example, by a profile within the winding apparatus, wherein the profile can be provided, for example, as a pulley within the winding apparatus. Alternatively, a movable cable guide can also be used to enable the traction cable to be wound up in a single layer. In other words, the winding apparatus can comprise profiles and/or movable cable guides for the preferably single-layered winding up of the traction cable.

The electronic module also comprises a control device which is configured to carry out the counterbalancing operation with respect to the weight force of the object. Within the context of the invention, it is preferred that primarily the apparatus for winding up the traction cable, the motor and the control apparatus are supplied with electrical energy.

It is preferred for the purposes of the invention that a counterforce for the weight force of the object is determined during the counterbalancing operation, such that the weight force of the object is counterbalanced or compensated for by the counterforce acting in the opposite direction to the weight force. Preferably, the counterforce can be transferred to the object using the traction cable. As a result, the weight of the object can be “removed” from a user of the system, such that the user—for example while working with the object—does not have to hold the latter at a certain height, but rather only has to use the arms to apply the force that is required to do the specific work to be done with the object. A substantial advantage of the invention consists in that the weight forces arising when using the system or when working with the object can be dissipated via the back structure into the user's hip region. In other words, the system is configured to dissipate the weight forces and loads that occur into the user's hip region. For this purpose, the back structure can be designed as a backpack system, for example.

It is particularly preferred for the purposes of the invention that, with the counterbalancing operation, a torque of the motor can be determined depending on the weight force of the object. The torque determined can be used to wind up or release the traction cable, depending on how great the weight force of the object is or to what extent the weight force of the object changes.

It is preferred for the purposes of the invention that the system or the electronic module has a transmission. It is preferred for the purposes of the invention that the transmission has a transmission ratio between 2 and 15 and preferably between 4 and 12. In addition, the transmission can have a pulley at its output, the pulley having a diameter in a range from 10 to 200 mm, preferably in a range from 20 to 150 mm and particularly preferably in a range from 40 to 120 mm. Tests have shown that a combination of a transmission ratio in a range of 4 to 12 and a pulley diameter of 40 to 120 mm represents a good compromise so that, although the motor of the system is capable of generating a sufficiently large torque, on the other hand it can be compact in order to be used in a body-borne counterbalancing system. It is preferred for the purposes of the invention that the motor is an external rotor motor. Advantageously, high torques can be achieved at low rotational speeds by using an external rotor motor. In addition, it is preferred for the purposes of the invention that the motor has a number of poles greater than 6. This makes it possible to provide a continuously high torque.

For the purposes of the invention, it is preferred that the traction cable is guided by means of pulleys and/or a Bowden cable. The Bowden cable can in particular comprise a Bowden cable or can be formed by one. It is preferred for the purposes of the invention that the traction cable is guided in or on the cantilever and thus leads from the object to be held, the weight of which is to be compensated, to the winding apparatus.

It is preferred for the purposes of the invention that the back structure comprises a first contact region and a second contact region, wherein contact between the user of the system and the system is provided at least in the contact regions. The first contact region can preferably be designed as a hip belt, while the second contact region can be designed as back padding. It is preferred for the purposes of the invention that the weight of the system can be optimally transferred to a stable body region of the system user by using a hip belt as the first contact region. In other words, a large proportion of the weight of the system is admitted to the hip belt and distributed by the latter to a stable body region of the user. As a result, the wearing comfort of the system can be significantly increased.

It is preferred for the purposes of the invention that the first and the second contact region are components of the back structure of the system. The first contact region is preferably formed by a hip belt that the user can put around their hips. The second contact region can be formed in particular by back padding that lies between or on the shoulder blades and can be connected to two shoulder straps. As known in the sphere of backpacks, the shoulder straps can be guided over the shoulders of the system user and end in the hip belt of the back structure. The backpack-like design of the back structure makes it easier to use the system and significantly increases its acceptance among users.

A distance between the first contact region and the second contact region is preferably designed to be adjustable in order to adapt the system to the user and to counterbalance a tilting moment caused by the object. This tilting moment preferably acts in the spatial direction “forward”, such that the user of the system can be pulled in the spatial direction “forward” when using the system and in particular when a heavy object is fastened to the traction cable. It is preferred for the purposes of the invention that the tilting moment is considered as acting about a horizontal axis of the system. This can be the first or second horizontal axis of the system, for example. In order to optimally counterbalance said tilting moment, it is preferred for the purposes of the invention that the distance between the first contact region and the second contact region of the back structure of the system is chosen to be as large as possible in order to achieve good leverage. This is made possible in particular by the adjustability of the distance between the first contact region and the second contact region of the back structure. Tests have shown that, with the invention, a tilting moment which is caused by the object and which preferably acts in a spatial direction “forward”, can be counterbalanced particularly well. The counterbalancing takes place in particular via the back of the user of the system, by the forces or the tilting moment being introduced into the back structure of the system.

In particular, the system has a linear guide that can be used to adjust the distance between the back padding and the hip belt. In this way, the user can set a respectively possible maximum distance between the first and the second contact region of the back structure, in a manner adapted to the user's height. The linear guide thus makes a significant contribution to compensating for the tilting moment by the object, the weight of which is to be counterbalanced by the system.

It is preferred for the purposes of the invention that the system has a strut in order to introduce a tilting moment caused by the object into a first contact region of the system. Preferably, the tilting moment is directed in particular into the hip belt of the system, where it is distributed over a stable body region of the user. The conducting away of the tilting moment can be further improved by the provision of the strut. For the purposes of the invention, it is preferred that the strut connects the back structure to the hip belt. The strut can be reinforced with a flexible plate to improve the introduction of force into the hip belt. This preferred configuration of the invention is illustrated in FIG. 3.

It is preferred for the purposes of the invention that the cantilever is designed to be foldable. For this purpose, the cantilever can comprise at least one joint. For example, the joint can be arranged in the back section or in the head section or in the transition region between the back section and the head section of the cantilever. A combination of different joints is also possible. Since the cantilever is foldable, a pack size for the folded-up system can be reduced, and therefore the system can be transported more easily when not in use. In addition, the fact that the system is foldable makes it easier to handle. The foldability of the cantilever can be made possible by various methods and apparatuses.

For example, a joint can be provided in the back section of the cantilever, which divides the back section into an upper region and a lower region and allows the upper region of the back section and the head section of the cantilever to be tilted or folded forward. The effect achieved by this in particular is that the cantilever can be folded forward between the shoulder straps of the back structure, as a result of which the pack size of the system can be significantly reduced. This preferred configuration of the invention is illustrated in FIG. 6.

In addition, it can be preferred for the purposes of the invention that the lower region of the back section of the cantilever can be lowered in the back structure of the system. This feature of the invention is illustrated in FIG. 8 and can be combined, for example, with the forward-folding embodiment of the invention illustrated in FIG. 6, such that the pack size of the folded-up system can be further considerably reduced. In this embodiment of the invention, a cavity for receiving the lower region of the back section of the cantilever can be provided in the back structure, into which cavity the lower region of the back section of the cantilever can be pushed. Furthermore, a latching mechanism can be provided with which the back section can be fastened in the various positions. For the purposes of the invention, it is particularly preferred that the back section of the cantilever can be fixed in the lowered position and in the maximally extended position. In addition, it can be preferred that the back section is also fastenable in intermediate positions in the back structure of the system. This means that different working heights of the system can be set, for example. It can also be determined in this way whether the cantilever is guided over the system user's head or next to their head.

It can also be preferred for the purposes of the invention that the transition region between the back section and the head section of the cantilever is designed as a joint, the joint making it possible for the head section of the cantilever to be folded rearward. As a result, on the one hand, the pack size of a system according to this embodiment of the invention can be reduced, and on the other hand, it can be made possible for the system to be able to be carried by its user in the manner of a backpack. This preferred configuration of the invention is illustrated in FIG. 7.

The system can furthermore be designed in such a way that the head section of the cantilever can be rotated to the side by a rotation angle about a vertical axis of rotation. The head section of the cantilever can then be folded in a spatial direction “downward” next to the user's body. This preferred embodiment of the invention is illustrated in FIG. 9. It is particularly preferred for the purposes of the invention that the head section of the cantilever is rotated to the side substantially by 90 degrees about a vertical axis of rotation before it is folded “downward” next to the user's body. A person skilled in the art knows that the term “substantially 90 degrees” is not an unclear term. The term “substantially 90 degrees” preferably means for the purposes of the invention that an angle of approx. 90 degrees is therefore meant, but this can, however, deviate from a mathematically exact right angle by +/−5 degrees, for example.

In a further preferred embodiment of the invention, the head section of the cantilever can comprise a joint, the joint dividing the head section of the cantilever arm into a front region and a rear region. Preferably, the joint allows the front region of the head section of the cantilever to be folded rearward, thereby enabling the pack size of the folded-up system to be reduced. In this embodiment of the invention, the front region of the head section of the cantilever is preferably folded rearward about a vertical axis of rotation, the vertical axis of rotation running through the joint dividing the head section of the cantilever into a front region and a rear region. This preferred configuration of the invention is illustrated in FIG. 10.

It is preferred for the purposes of the invention that the cantilever comprises a support point with which the system can be supported on a wall. The provision of such a support point, which is preferably present at the front end of the head section of the cantilever, advantageously makes it possible to absorb the tilting moment that acts forward in the spatial direction and is caused by the object, such that the user of the system can work with the object in a particularly stable and safe manner. It is preferred for the purposes of the invention that the support point comprises an elastic material and/or at least one pulley or is formed by the elastic material and/or the at least one pulley. Owing to the elastic material, damage to the wall on which the system is supported with the support point can be avoided. The use of pulleys provides a certain mobility of the support point, with which the dynamic character of working with power tools can be taken into account. This preferred embodiment of the invention is illustrated in FIG. 11. Preferably, the support point can also be referred to as a contact point for the purposes of the invention, which is preferably arranged in the region of a tip of the cantilever, i.e. its front or first end. The system can be supported by the provision of the support point or contact point on a wall, such that the tilting moment no longer acts on the user but rather is kept away from them.

In a further embodiment of the invention, the head section of the cantilever can be designed to be telescopic in the horizontal direction. As a result, different lengths of the head section of the cantilever can advantageously be set. In this way, the system can be adapted in a particularly simple and uncomplicated manner to various objects that can be fastened to the traction cable of the system. When the object is a power tool, with the head section differing in length, differing tool lengths of the power tool can be addressed. For example, power tools can have tools of differing lengths, depending on whether the power tool is a chiseling device, a hammer drill, a core drilling device or some other power tool. The system can be used particularly flexibly in different trades and for different types of power tools owing to the head section of the cantilever arm, which is preferably designed to be telescopic.

In a second aspect, the invention relates to an electronic module for counterbalancing a weight force of an object. The terms, definitions and technical advantages introduced for the system and the components thereof preferably apply analogously to the electronic module. Within the context of the electronic module, the object, the weight of which is to be counterbalanced, is fastened to the module with a traction cable. The electronic module has the following components for counterbalancing a weight force of an object:
an apparatus for winding up a traction cable, and
a motor for driving the apparatus for winding up a traction cable,

wherein the system is configured to determine a counterforce for the weight force of the object and to transmit same to the object. It is particularly preferred for the purposes of the invention that a control device of the system is configured to adjust a counterforce with respect to the weight force of the object. The system can preferably be configured, for example by means of its control device, to create a force balance between the weight force of the object on the one hand and the counterforce on the other hand. In particular, the system can preferably be configured to carry out a counterbalancing operation with respect to the weight force of the object. In addition to the body-borne design of the system, the electronic module can also be provided as a stand-alone apparatus. In this way, it no longer has to be carried by a user using the back structure, but rather can be implemented as an external structure. Within the context of this aspect of the invention, the electronic module can be set up at a work site, with an object being able to be fastened to the electronic module using a traction cable and optionally deflection pulleys or similar aids.

In this respect, the invention includes, in a further aspect, a kit comprising the electronic module, a traction cable and at least one deflection pulley for counterbalancing a weight force of an object which is fastenable to the traction cable. This preferred configuration of the invention is illustrated in FIG. 12. The at least one deflection pulley can be attached to a ceiling above a work site, for example. Suitable carrier structures or frame structures can be used for this purpose. It can also be preferred for the purposes of the invention that the carrier structure or frame structure is designed as a guide rail, such that a position of the kit can be changed. In other words, a mobile work kit can be provided in this way for counterbalancing a weight force of an object, wherein the object can be designed in particular as a power tool.

Further advantages will become apparent from the following description of the figures. The figures, the description and the claims contain numerous features in combination. A person skilled in the art will expediently also consider the features individually and combine them to form useful further combinations. Identical and similar components are denoted by the same reference signs in the figures, in which:

### BRIEF DESCRIPTION OF THE DRAWINGS

FIG. 1 shows a view of a preferred embodiment of the system

FIG. 2 shows a view of a preferred embodiment of the system with a length-adjustable back structure

FIG. 3 shows a view of a preferred embodiment of the system with a support strut

FIG. 4 shows a view of a preferred embodiment of the system, wherein the head section of the cantilever extends over the user's head

FIG. 5 shows a view of a preferred embodiment of the-system, wherein the head section of the cantilever runs next to the user's head

FIG. 6 shows a view of a preferred embodiment of the system with a joint in the back section of the cantilever

FIG. 7 shows a view of a preferred embodiment of the system with a joint in the transition region between the back section and the head section of the cantilever

FIG. 8 shows a view of a preferred embodiment of the system, in which the back section of the cantilever can be lowered in the back structure

FIG. 9 shows a view of a preferred embodiment of the system with a rotatable and foldable cantilever

FIG. 10 shows a view of a preferred embodiment of the system with a joint in the head section of the cantilever

FIG. 11 shows a view of a preferred embodiment of the system with a support point or contact point for a wall

FIG. 12 shows a view of a preferred embodiment of the kit as a stand-alone apparatus

### DETAILED DESCRIPTION

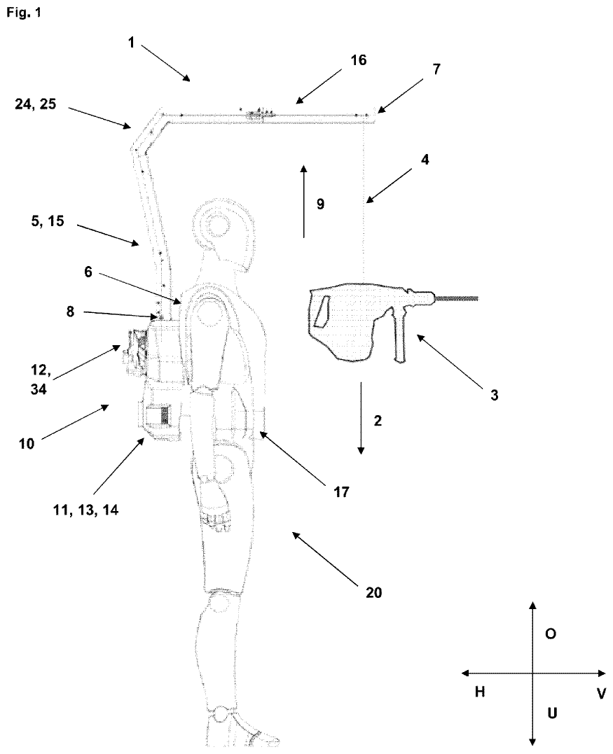

FIG. 1 shows a preferred embodiment of the system 1, which is carried by a user 20. The system 1 comprises a cantilever 5 which runs above the head 21 of the user 20 in the example of the invention shown in FIG. 1. The cantilever 5 can have sections which are referred to as the back section 15, head section 16 and transition section 25. The back section 15 is arranged in a back region or rear region of the system 1 and runs substantially parallel to a spine of the user 20. The head section 16 runs substantially perpendicularly to the back section 15 of the cantilever 5, such that the back section 15 and the head section 16 substantially enclose a right angle. The cantilever 5 can be L-shaped or have a transition region 24 which has a transition section 25 arranged obliquely between the back section 15 and the head section 16. The cantilever 5 has a front or first end 7 and a second or rear end 8 which opens into the back structure 6 of the system 1. The back structure 6 makes it possible for the user 20 to carry the system 1 on their back. An electronic module 10 that contains various components of the system 1 is provided in the back region of the user 20. In particular, an energy source 11, an apparatus 12 for winding up a traction cable 4, a control device 14 and a motor 13 are accommodated in the electronic module 10. The back structure 6 or the electronic module 10 can be fastened on the user 20 with a first contact region 17 and a second contact region 18. The first contact region 17 can be designed as a hip belt, while the second contact region 18 is preferably designed as back padding. An object 3 having a weight force 2 can be fastened to the traction cable 4. The weight force 2 is preferably the weight of the object 3, wherein the weight force 2 points in the direction of the ground. For the purposes of the invention, this direction is preferably referred to as the “downward U” spatial direction. The other spatial directions “upward O”, “forward V” or “backward H” are also shown in FIG. 1. The downward arrow, which is provided with the reference sign 2, symbolizes the weight force 2 of the object 3 and indicates its direction. The object 3 can preferably be in the form of a power tool and can be fastened to the system 1 via the traction cable 4. Simple fastening means, such as snap hooks, or special fastening means or receiving devices can be used for this purpose.

The traction cable 4 leads from the object 3 in the direction of the cantilever 5 and is then guided in or on the cantilever 5 in the direction of the back structure 6 or the electronic module 10. The winding apparatus 12 with which the traction cable 4 can be wound up is located in the electronic module 10. As a result, the effective length of the traction cable 4 can be extended or shortened. In particular, the length of the traction cable 4 can be adapted to the weight force 2 of the object 3, wherein the weight force 2 of the object 3 is determined in a counterbalancing operation. The winding apparatus 12 is driven by a motor 13 which can also be arranged in the electronic module 10. It is preferred for the purposes of the invention that the counterbalancing operation represents a regulating and control process, the aim of which is that the motor 13 is at a standstill. In other words, the motor 13 is regulated to a rotational speed of zero by the counterbalancing operation. With the counterbalancing operation, the system 1 enables a weight force 2 of the object 3 to be compensated for, such that the system 1 can preferably also be referred to as a balancing system. The weight force 2 is preferably compensated for by an interaction between the winding apparatus 12, the motor 13, and the control device 14, wherein the mentioned components of the system 1 are supplied with electrical energy by the energy source 11. The energy source 11 is preferably a battery or a power pack. The weight force 2 of the object 3 is compensated for in particular by a counterforce 9 which is exerted on the object 3 and transmitted to the object 3 by means of the traction cable 4. In other words, the counterforce 9 counterbalances the weight force 2 of the object 3 and thus ensures that the user 20 of the system 1 does not have to hold the object 3 against gravitational force, but has to apply only the force required to work with the object 3. As a result, the system 1 can make the work with the object 3 much easier for the user 20. The counterforce 9 is marked in the figures with an arrow in the spatial direction “upward” and the reference sign 9.

A counterbalancing operation takes place in particular when a (new) object 3 is fastened to the traction cable 4 or when the object 3 is exchanged. In particular, the compensation for the weight force 2 of the object 3 can be regulated statically to the weight thereof. However, it can also be preferred for the purposes of the invention that the counterbalancing operation takes place continuously and that the counterforce 9 is dynamically adapted to changes in the weight force 2 that may occur briefly when working with the object 3.

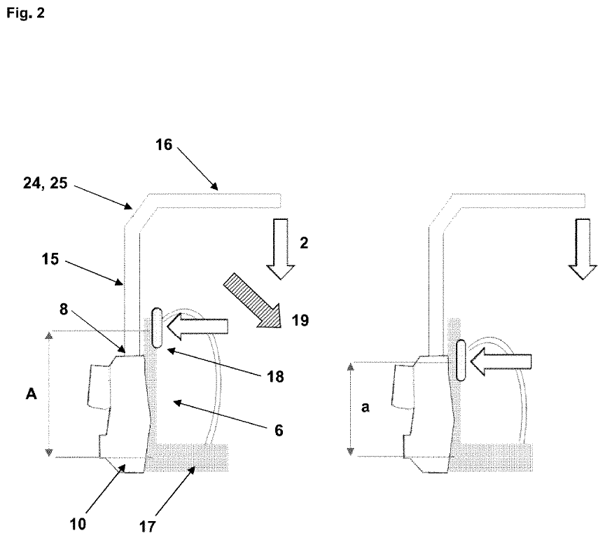

FIG. 2 shows a preferred embodiment of the system 1 with a length-adjustable back structure 6. In particular, in the exemplary embodiment of the invention shown in FIG. 2, a distance A between the first contact region 17 and the second contact region 18 of the back structure 6 can be set. For the purposes of the invention, it is very particularly preferred that the distance A between a hip belt 17 and a back padding 18 of the back structure 6 can be adjusted. Owing to the adjustability of the distance A between the hip belt 17 and the back padding 18, a tilting moment 19 generated by the object 3 can be compensated for. The tilting moment 19 is shown in FIG. 2 with a hatched arrow and the reference sign 19. The tilting moment 19 is caused by the weight force 2 of the object 3, which pulls the system 1 in the spatial direction downward U. As a result, a tilting moment 19 acts overall, which acts downward and forward and in particular pulls the cantilever 5 of the system 1 in this direction. It has been shown that a particularly large distance A between the hip belt 17 and the back padding 18 as the contact surfaces between the back structure 6 and the user 20 counterbalances this tilting moment 19 particularly effectively, since particularly good leverage conditions prevail in this way. The left half of FIG. 2 shows a large distance A between hip belt 17 and back padding 18, which is symbolized by a capital letter A, while the right half of FIG. 2 shows a small distance a between hip belt 17 and back padding 18, which is symbolized by a lower-case letter a. In addition, the individual sections 15, 16, 25 of the cantilever 5 are shown in FIG. 2, wherein the cantilever 5 can comprise a back section 15, a head section 16, and a transition section 25. While the back section 15 and the head section 16 are arranged substantially perpendicularly to one another, the transition section 25 is present in a transition region 24 between the back section 15 and the head section 16 of the cantilever 5. The adjustability of the distance A can be made possible in particular by the provision of a linear guide.

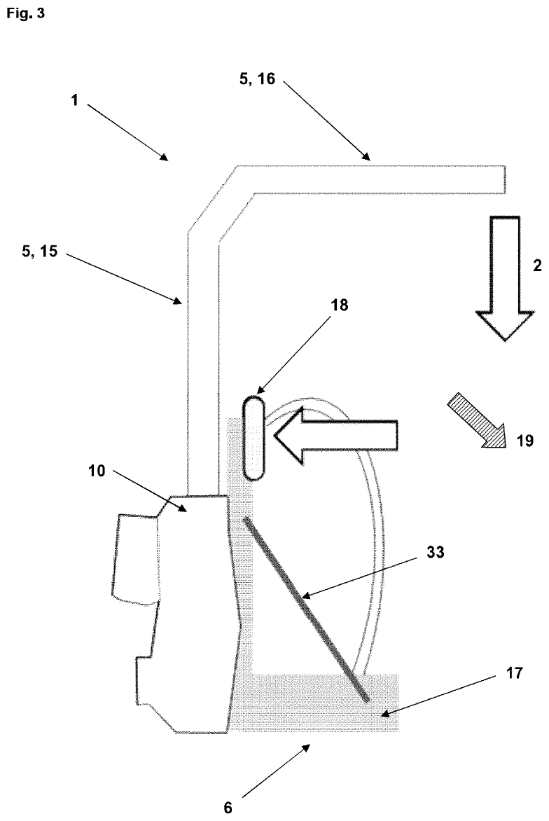

FIG. 3 shows a preferred embodiment of the system 1 with a support strut 33 which can be arranged between the hip belt 17 and the back padding 18 of the back structure 6. The introduction of the tilting moment 19 into the back structure 6, in particular into the hip belt 17, can be further improved with the support strut 33, such that the support strut 33 enables an improved introduction of force into the hip belt 17, as well as further improved relieving of load for the user 20.

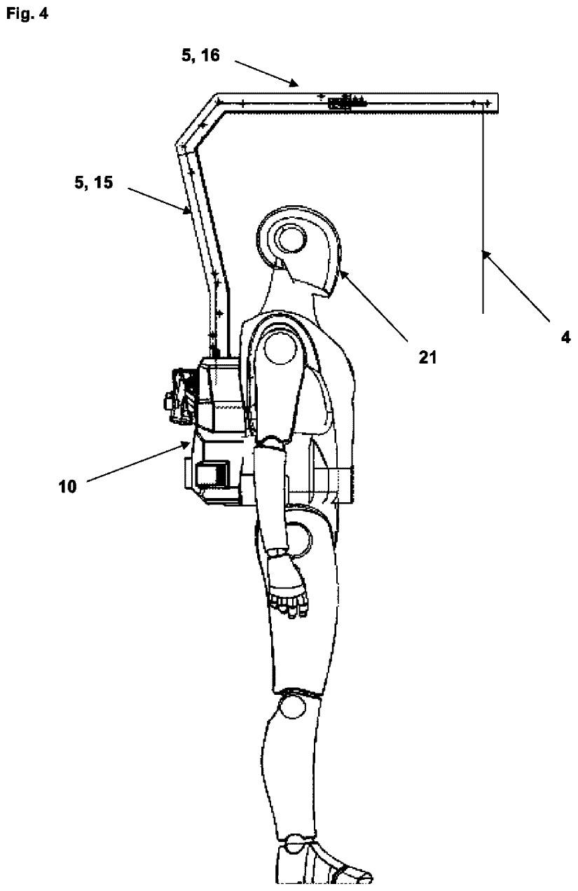

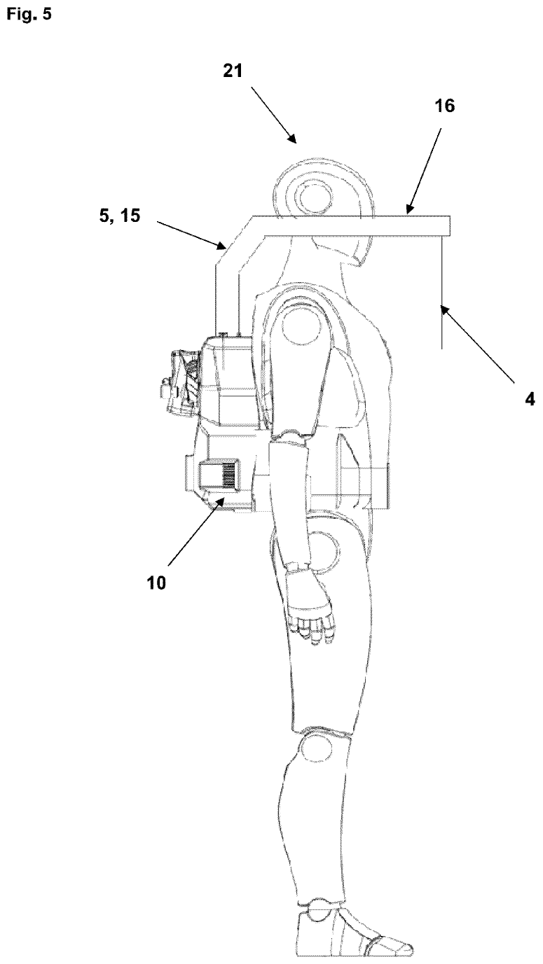

FIG. 4 shows a preferred embodiment of the system 1, wherein the head section 16 of the cantilever 5 extends over the head 21 of the user 20, while FIG. 5 shows a preferred embodiment of the system 1, in which the head section 16 of the cantilever 5 runs next to the head 21 of the user 20. Owing to the different possible configurations of the system 1, the system 1 can be used together with different objects 3 or power tools. This makes it particularly versatile to use and it can be used, for example, by craftsmen from different trades. In addition, different types of power tools can be fastened to the traction cable 4 of the system 1.

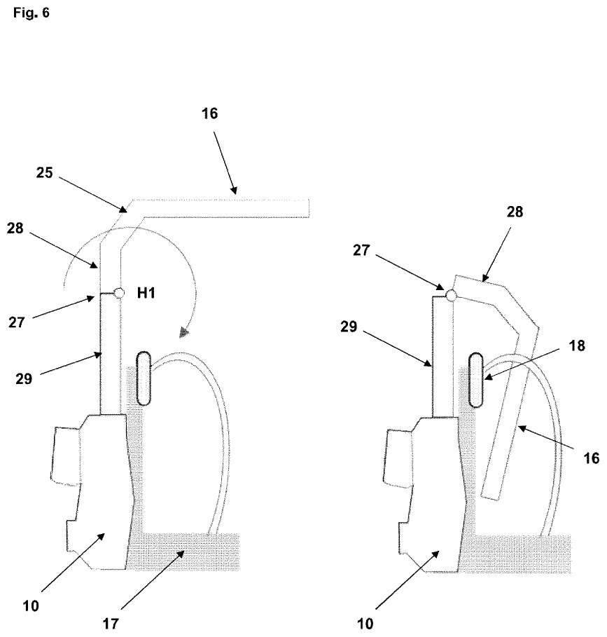

FIG. 6 shows a preferred embodiment of the system 1 with a joint 27 in the back section 15 of the cantilever 5. For the purposes of the invention, it is preferred that at least one joint 26, 27, 30 is arranged in the cantilever 5 of the system 1, such that the cantilever 5 is foldable. For example, the joint 27 divides the back section 15 of the cantilever 5 into an upper part 28 and a lower part 29, the upper part 28 together with the head section 16 of the cantilever 5 being able to be folded in a spatial direction forward. This rotatability of the upper region 28 of the back section 15 and of the head section 16 of the cantilever 5 is indicated in FIG. 6 by the circular arrow. For the purposes of the invention, it is preferred that the rotation of the upper region 28 of the back section 15 and of the head section 16 of the cantilever 5 takes place about a first horizontal axis H1, which preferably runs through the joint 27 in the back section 15 of the cantilever 5. The upper part 28 and the head section 16 of the cantilever 5 can, for example, be placed next to the head 21 of the user 20 and the system 1 can be carried particularly easily as a backpack in this embodiment of the invention and owing to the small pack size. It is preferred for the purposes of the invention that the lower region 29 of the back section 15 terminates at the bottom with the second or rear end 8 of the cantilever 5.

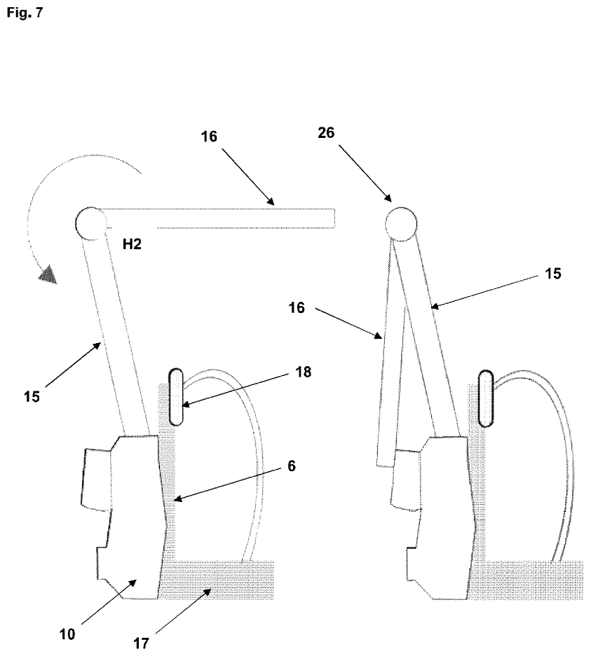

FIG. 7 shows a preferred embodiment of the system 1 with a joint 26 in the transition region 24 between the back section 15 and the head section 16 of the cantilever 5. In this embodiment of the invention, the head section 16 of the cantilever 5 can be folded forward about a second horizontal axis H2, such that the pack size of the folded-up system 1 is also significantly reduced.

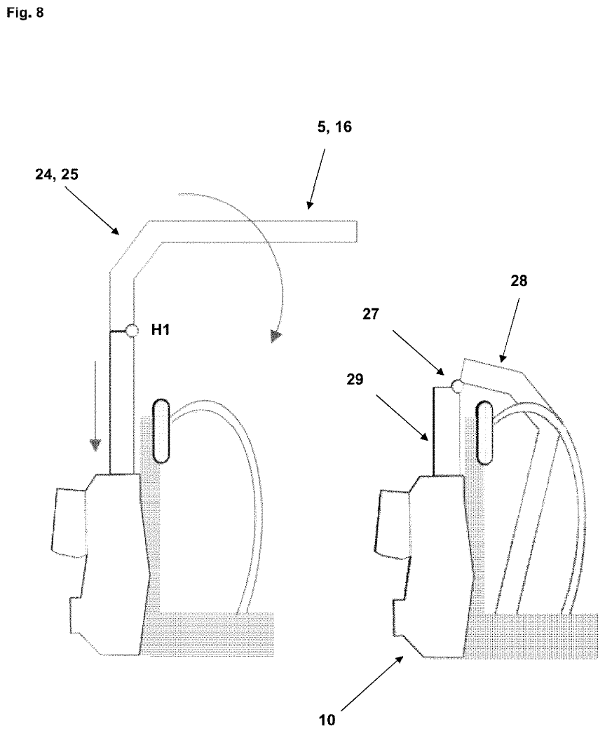

In order to further reduce the pack size, the lower part 29 of the back section 15 of the cantilever 5 can be retracted into the back structure 6. This embodiment of the invention is shown in FIG. 8, wherein the retractability of the back section 15 of the cantilever 5 into the back structure 6 is symbolized by the downwardly pointing arrow running parallel to the back section 15. Analogously to FIG. 6, FIG. 8 shows an embodiment of the system in which a joint 27 is provided in the back section 15 of the cantilever 5, which joint divides the back section 15 into an upper region 28 and a lower region 29. Also shown in FIGS. 6 to 8 are the contact regions 17, 18, which can be formed by a hip belt and back padding and which preferably form the back structure 6 of the balancing system 1. Of course, it is also possible to combine the retractability of the back section 15 of the cantilever 5 with the embodiment of the invention shown in FIG. 7, in which the joint 26 is arranged in the transition region 25 between the back section 15 and the head section 16 of the cantilever 5.

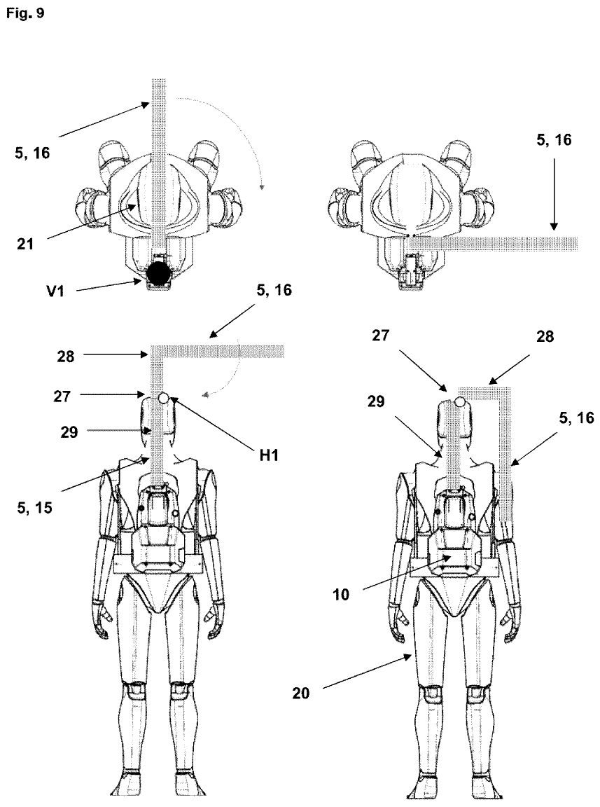

FIG. 9 shows a preferred embodiment of the system 1 with a rotatable and foldable cantilever 5. The upper figures of FIG. 9 show a top view from above of a preferred embodiment of the system 1, in which the cantilever 5 can be rotated to the side about a first vertical axis V1 by an angle of rotation. The angle of rotation can be, for example, substantially 90 degrees, that is to say can represent an essentially right angle. Preferably, the first vertical axis V1 is substantially parallel to the back section 15 of the cantilever 5 and protrudes out of the plane of the drawing of the upper figures in FIG. 9, i.e. coming toward the reader. In the upper right image of FIG. 9, the head section 16 of the cantilever 5 is rotated through a right angle compared to the initial state (cf. upper left image of FIG. 9) of the system 1. For the purposes of this embodiment of the invention, it is preferred that the cantilever 5 has a joint 26, 27 (see FIG. 7 and FIG. 8 respectively), such that an upper region of the cantilever 5 can be folded downward next to the body of the user 20 after the rotation. This rotatability of the cantilever 5 is indicated by the round arrow in the lower left image of FIG. 9. In the lower right image of FIG. 9, the system 1 is shown in the folded-up state when the upper region of the cantilever 5 is folded to the side or downward next to the body of the user 20. The folding downward takes place about a horizontal axis of rotation H1, H2, which preferably runs substantially horizontally through the joint 26, 27 in the cantilever 5 of the system 1. The joint 26, 27 can be, for example, a joint 26 in the transition region 24 between the back section 15 and head section 16 of the cantilever 5 or a joint 27 in the back section 15 of the cantilever 5, which divides the back section 15 into an upper region 28 and a lower region 29. In the lower images of FIG. 9, an embodiment of the system with a joint 27 in the back section 15 of the cantilever 5 is shown.

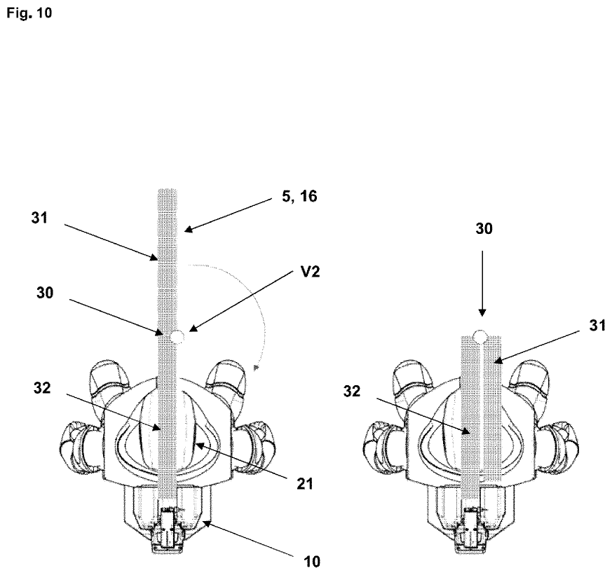

FIG. 10 shows a preferred embodiment of the system 1 with a joint 30 in the head section 16 of the cantilever 5. The two images of FIG. 10 show, in particular, a top view of a preferred embodiment of the system 1, with the joint 30 dividing the head section 16 of the cantilever 5 into a front region 31 and a rear region 32. Preferably, the front end of the front region 31 of the head section 16 of the cantilever 5 is referred to as the first or front end 7 of the cantilever 5. It is preferred for the purposes of the invention that the front region 31 of the head section 16 of the cantilever 5 can be folded to the side about a second vertical axis V2 in such a way that the front region 31 of the head section 16 of the cantilever 5 comes to lie next to the rear region 32 of the head section 16 of the cantilever 5. In other words, the front region 31 and the rear region 32 of the head section 16 of the cantilever 5—as shown in the right image of FIG. 10—are substantially parallel to one another. This rotatability about the second vertical axis V2 can in particular reduce the extent of the system 1 in a side view. It is preferred for the purposes of the invention that the second vertical axis V2 runs substantially parallel to the back section 15 of the cantilever 5 or a spine of the user 20 and protrudes from the plane of the drawing of FIG. 10. In other words: the second vertical axis V2 comes toward the reader. The second vertical axis V2 preferably runs through the joint 30 in the head section 16 of the cantilever 5.

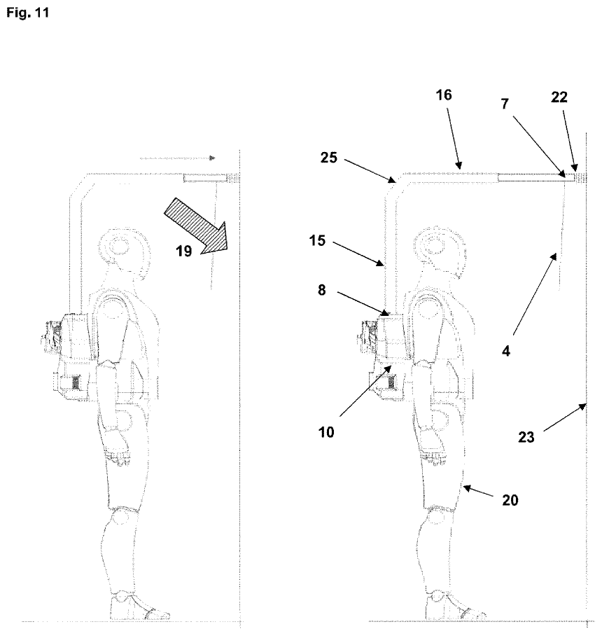

FIG. 11 shows a preferred embodiment of the system 1 with a support point or contact point 22 for a wall 23. With this embodiment of the invention, the tilting moment 19 caused by the object 3 can be absorbed even better by the system 1. The support point or contact point 22 is arranged in particular in the front end 7 of the cantilever 5 and may comprise an elastic material or at least one pulley, wherein the elastic material or the pulley comes into contact with a wall 23. The wall 23 can be, for example, masonry, a wall or a substrate that is to be machined with the object 3, which is preferably designed as a power tool. With the support point or contact point 22, the system 1 or the user 20 of the system 1 can be supported on the wall 23 to be machined, such that the tilting moment 19 caused by the object 3 is introduced directly into the wall 23 and so does not constitute any load for the user 20 of the system 1. As a result, the user 20 of the system 1 can be further considerably relieved of load and supported when working with a power tool.

FIG. 11 furthermore shows that the head section 16 of the cantilever 5 can be designed to be telescopic, with the telescoping ability of the head section 16 of the cantilever 5 being present in particular in the horizontal direction. It is indicated in FIG. 10 by the arrow running above and parallel to the head section 16. The telescoping ability of the head section 16 makes it possible to use different tools on the object 3, which is preferably designed as a power tool, and to work with them. In particular, the system 1 can be particularly easily adapted to different tool lengths of the power tool because of the telescoping ability of the head section 16 of the cantilever 5.

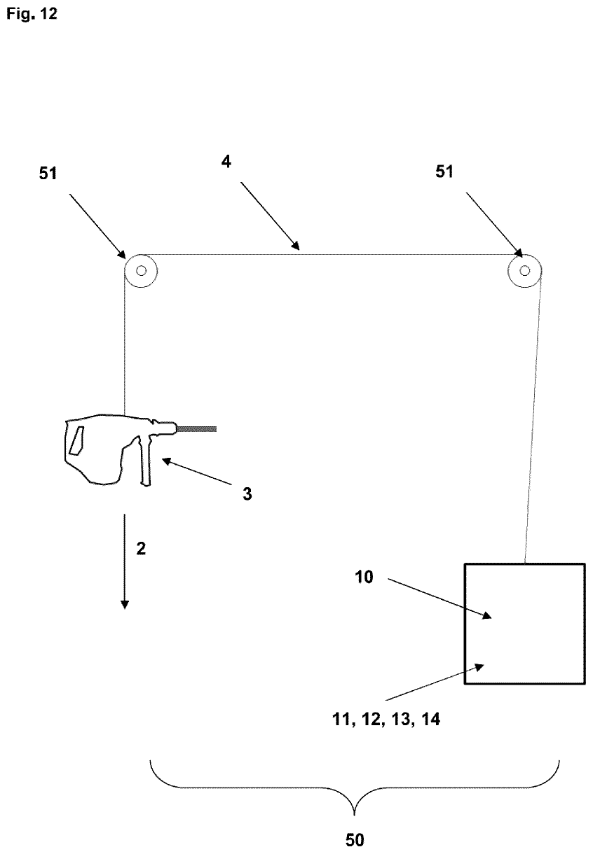

FIG. 12 shows a preferred embodiment of the kit 50 as a stand-alone apparatus. In addition to the system 1, the invention relates in further aspects to an electronic module 10 and to a kit 50, the kit 50 comprising an electronic module 10, at least one traction cable 4 and a deflection pulley 51. An object 3 can be fastened to the traction cable 4, wherein an effective length of the traction cable 4—analogously to that described for the system 1—can be shortened or extended by a winding apparatus 12 of the electronic module 10, such that a weight or a weight force 2 of the object 3 is counterbalanced. The electronic module 10 in each case comprises such a winding unit 12, a motor 13 with which the winding unit 12 can be driven, an energy source 11 for the electrical supply of the electronic module 10 and its components 12, 13, 14, and a control unit 14, which is responsible for the counterbalancing operation. With the counterbalancing operation, the torque generated by the motor 13 can be regulated, controlled and in particular adapted to the weight of the object 3, such that the weight force 2 of the object 3 is compensated for. The kit 50 can be set up as a stand-alone apparatus at a desired work site, for example, and can be transported particularly easily.

### LIST OF REFERENCE SIGNS

1 System
2 Weight force
3 Object
4 Traction cable
5 Cantilever
6 Back structure
7 First, front end of the cantilever
8 Second, rear end of the cantilever
9 Counterforce
10 Electronic module
11 Energy source
12 Apparatus for winding up the traction cable
13 Motor
14 Control device
15 Back section of the cantilever
16 Head section of the cantilever
17 First contact region, hip belt
18 Second contact region, back padding
19 Tilting moment
20 User
21 User's head
22 Support point or contact point
23 Wall
24 Transition region
25 Transition section
26 Joint in the transition region between the back section and the head section of the cantilever
27 Joint in the back section of the cantilever
28 Upper region of the back section of the cantilever
29 Lower region of the back section of the cantilever
30 Joint in the head section of the cantilever
31 Front region in the head section of the cantilever
32 Rear region in the head section of the cantilever
33 Support strut
34 Transmission
50 Kit
51 Deflection pulley
A distance
V front
H rear
O top
U bottom
H1 first horizontal axis
H2 second horizontal axis
V1 first vertical axis
V2 second vertical axis

What is claimed is:

1-15. (canceled)

16. A system for counterbalancing a weight force of an object fastenable to a traction cable guidable in or on a cantilever in the direction of a back structure of the system, the system comprising:
an electronic module including:
an energy source for supplying the system with electrical energy;
a winder for winding up the traction cable;
a motor for driving the winder; and
a controller;
the system configured to determine a counterforce for the weight force of the object and to transmit the counterforce to the object.

17. The system as recited in claim 16 wherein the counterforce is determined in a counterbalancing operation such that the weight force of the object is counterbalanced by the counterforce directed counter to the weight force.

18. The system as recited in claim 17 wherein with the counterbalancing operation, a torque of the motor is determinable depending on the weight force of the object.

19. The system as recited in claim 16 wherein the winder for winding up the traction cable is arranged in a region of the back structure and the traction cable is windable up using the motor and the winder.

20. The system as recited in claim 16 wherein the traction cable is guided via pulleys or a Bowden cable.

21. The system as recited in claim 16 wherein the cantilever is accommodatable by the back structure.

22. The system as recited in claim 16 wherein the cantilever includes a back section and a head section arranged perpendicular to one another.

23. The system as recited in claim 16 wherein the back structure includes a first contact region and a second contact region for contact with a user of the system.

24. The system as recited in claim 23 wherein a distance A between the first contact region and the second contact region is adjustable in order to adapt the system to the user and to counterbalance a tilting moment caused by the object.

25. The system as recited in claim 16 further comprising a support strut in order to introduce a tilting moment caused by the object into a first contact region of the system.

26. The system as recited in claim 16 wherein the cantilever is guidable over a head of a user or next to the head of the user.

27. The system as recited in claim 16 wherein the cantilever has at least one joint so that the cantilever is foldable.

28. The system as recited in claim 16 wherein the cantilever includes a support point for supporting the system on a wall.

29. An electronic module for counterbalancing a weight force of an object fastenable to the electronic module with a traction cable, the electronic module comprising:
an energy source for supplying a system with electrical energy;
a winder for winding up the traction cable;
a motor for driving the winder; and
a controller;
the electronic module configured to determine a counterforce for the weight force of the object and to transmit the counterforce to the object.

30. A kit comprising: the electronic module as recited in claim 29, the traction cable and at least one deflection pulley for counterbalancing the weight force of the object.
